(19) United States
(12) Patent Application Publication
(10) Pub. No.: US 2018/0047499 A1
(43) Pub. Date: Feb. 15, 2018

(54) DISTRIBUTION TRANSFORMER AND INTEGRATED POWER CONDITIONING DEVICE

(71) Applicant: Cooper Technologies Company, Houston, TX (US)

(72) Inventor: Richard James Smith, Waukesha, WI (US)

(21) Appl. No.: 15/672,536

(22) Filed: Aug. 9, 2017

Related U.S. Application Data
(60) Provisional application No. 62/373,687, filed on Aug. 11, 2016.

(51) Int. Cl. H01F 27/32; H01F 30/12; H01F 27/30; H02M 1/44; H01F 27/24; H02M 3/335; H02M 1/32

(52) U.S. Cl. CPC H01F 27/321; H02M 3/33507; H01F 30/12; H02M 1/32; H02M 1/44; H01F 27/24; H01F 27/303; H01F 2027/404

(57) ABSTRACT

A power system having a transformer and integrated power conditioning device is disclosed. The transformer includes a fluid enclosure that holds transformer fluid therein that immerses a core and coil assembly. The power conditioning device is integrated with the transformer and connected thereto to receive an output power and is within an electrical enclosure. A power conditioning circuit is configured to perform power conversion and conditioning on the output power from the transformer. A first set of electrical conductors is coupled between the core and coil assembly and the power conditioning circuit to transfer the output power from the transformer to the power conditioning circuit and a second set of electrical conductors is coupled between the power conditioning circuit and electrical connections on a front plate of the fluid enclosure, the second set of electrical conductors being routed through the fluid enclosure of the transformer.

### CROSS-REFERENCE TO RELATED APPLICATION

The present application is a non-provisional of, and claims priority to, U.S. Provisional Patent Application Ser. No. 62/373,687, filed Aug. 11, 2016, the disclosure of which is incorporated herein by reference in its entirety.

### BACKGROUND OF THE INVENTION

Embodiments of the present invention relate generally to power distribution transformers, and, more particularly, to a distribution transformer having a power conditioning device integrated therewith.

Transformers, and similar devices, come in many different shapes and sizes for many different applications and uses. Fundamentally, all of these devices include at least one primary winding(s) with at least one core path(s) and at least one secondary winding(s) wrapped around the core(s). When a varying current (input) is passed through the primary winding a magnetic field is created which induces a varying magnetic flux in the core. The core is typically a highly magnetically permeable material which provides a path for this magnetic flux to pass through the secondary winding thereby inducing a voltage on the secondary (output) of the device.

Transformers are employed within distribution systems in order to transform voltage to a desired level and are sized by the current requirements of their connected load. If a load is connected to the secondary, an electric current will flow in the secondary winding and electrical energy will be transferred from the primary circuit, through the transformer, to the load. Transformers are designated by their power rating, typically in kVA, which describes the amount of energy per second that they can transfer and also by their primary and secondary operating voltages, typically in kV.

Transformers as described above can be connected to associated power electronics—with the power electronics being connected to the secondary to receive electrical energy therefrom and provide power conditioning thereto, such as controlling voltage, power factor and harmonics, for example. At present, such power electronics are provided separately from the transformer, with each of the power transformer and the power electronics being provided in its own dedicated housing and often being mounted on its own pad. Connections between the transformer and the power electronics are then made via the use of external cables that are close-coupled or separate to the transformer. For example, the external cables are often provided as underground connections that run between the transformer and the power electronics.

While the above described arrangement and connection of transformers and associated power electronics—within separate enclosures and on separate pads, being connected via external/underground cables—is sufficient for achieving a desired power transfer and power conditioning, it is recognized that such an arrangement/connection has drawbacks associated therewith. For example, it is recognized that the underground cables connecting the transformers and power electronics present an increased level of complexity and added cost to the low voltage connections of the distribution transformer front plate, with additional cables and low voltage terminals being required that crowd the connection compartment of the transformer. Additionally, the above described arrangement and connection of transformers and associated power electronics requires the purchase and installation (on separate pads) of separate pieces of equipment, with the non-standard installation of underground cables adding further to the cost/complexity of the installation.

Therefore, it would be desirable to provide a distribution transformer having a power conditioning device integrated therewith. Such an integrated unit would simplify the low voltage connections of the distribution transformer front plate and reduce the cost and complexity of purchase and installation of the transformer and its associated power electronics.

### BRIEF DESCRIPTION

In accordance with one aspect of the present invention, a power system comprises a transformer including a fluid enclosure having a front plate, a rear plate, and side surfaces, the fluid enclosure configured to hold a transformer fluid therein, and a core and coil assembly positioned within the fluid enclosure so as to be immersed in the transformer fluid, the core and coil assembly including a transformer core and a plurality of windings wound about the transformer core. The power system also comprises a power conditioning device integrated with the transformer and connected thereto to receive an output power from the transformer, the power conditioning device including an electrical enclosure and a power conditioning circuit housed within the electrical enclosure and configured to perform power conversion and conditioning on the output power from the transformer. The power system further comprises a first set of electrical conductors coupled between the core and coil assembly and the power conditioning circuit to transfer the output power from the transformer to the power conditioning circuit and a second set of electrical conductors coupled between the power conditioning circuit and electrical connections on the front plate of the fluid enclosure, the second set of electrical conductors being routed through the fluid enclosure of the transformer.

In accordance with another aspect of the present invention, an enclosure unit for an integrated transformer—power conditioning system includes a fluid tank configured to house a core and coil assembly of a transformer therein, with the fluid tank further including a front panel having electrical fittings thereon, a pair of side panels, and a rear panel, wherein one of the front panel, the side panels, and the rear panel comprises a plurality of openings formed therein. The enclosure unit also includes an electrical enclosure configured to house a power conditioning circuit therein, the electrical enclosure comprising a mounting panel having a plurality of openings formed therein, the mounting panel of the electrical enclosure mounted to the one of the front panel, the side panels, and the rear panel of the fluid tank having the plurality of openings formed therein. The enclosure unit further includes a plurality of electrical connectors positioned in the plurality of openings formed in the mounting panel of the electrical enclosure and in the plurality of openings formed in the one of the front panel, the side panels, and the rear panel of the fluid tank, the plurality of electrical connectors providing for a first set of electrical conductors to pass out from the fluid tank into the electrical enclosure and a second set of electrical conductors to pass out from the electrical enclosure back into the fluid tank.

In accordance with yet another aspect of the present invention, an integrated transformer-voltage conversion system includes a transformer comprising a fluid tank comprising a front plate, a rear plate and side panels, a core and coil assembly positioned within the tank and including a transformer core and a plurality of windings wound about the transformer core, and a transformer fluid contained within the fluid tank and immersing the core and coil assembly. The system also includes a power conditioning device mounted on one of the front plate, the rear plate, or a respective side panel of the fluid tank, the power conditioning device electrically connected to the transformer to receive an output power therefrom and perform a power conditioning and conversion on the output power. The system further includes a first set of electrical conductors coupled between the transformer and the power conditioning device to transfer the output power from the transformer to the power conditioning device and a second set of electrical conductors coupled between the power conditioning device and electrical connections on the front plate of the fluid tank, wherein the second set of electrical conductors is routed through the fluid enclosure of the transformer so as to be immersed in the transformer fluid.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a perspective view of a power system that includes a power conditioning device incorporated with a transformer, according to an embodiment of the invention.

FIG. 2 is a cross-sectional view of the power system of FIG. 1 taken along line 2-2, according to an embodiment of the invention.

FIG. 3 is a cross-sectional view of the power system of FIG. 1 taken along line 3-3, according to an embodiment of the invention.

FIG. 4 is a schematic view of a rear plate of the transformer of FIG. 1, according to an embodiment of the invention.

FIG. 5 is a schematic view of a front plate of the transformer of FIG. 1, according to an embodiment of the invention.

### DETAILED DESCRIPTION

Embodiments of the invention are directed to a power system that includes a distribution transformer and a power conditioning device integrated therewith. Power conditioning electronics are provided on a back panel of the transformer, outside of the main transformer fluid enclosure in which insulating fluid is contained, with low voltage connections being routed through the fluid enclosure from the power conditioning electronics to connections on a front plate of the enclosure.

While an operating environment of an exemplary embodiment of such a power system is described below with respect to the system including a three-phase liquid-filled transformer, it is recognized that embodiments of the invention are not limited to such an implementation. That is, it is recognized that embodiments of the invention are not to be limited to the specific transformer configurations set forth in detail below and that all single-phase and three-phase transformers, voltage regulators, and distribution equipment are recognized to fall within the scope of the invention. According to additional embodiments, power conditioning electronics may be incorporated with medium transformers as well as large power, substation, solar power, generator step-up, auxiliary, auto, and grounding transformers, for example.

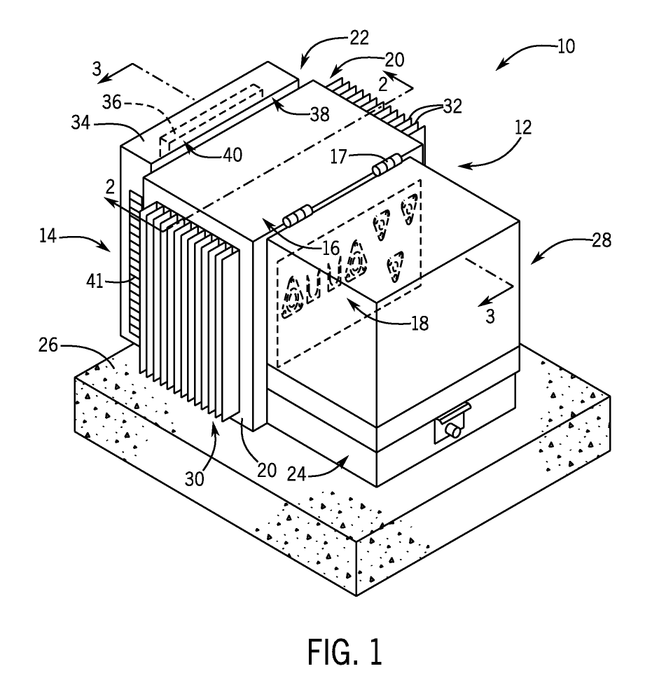

Referring to FIG. 1, an exemplary power system 10 is shown according to an embodiment of the invention. The system 10 includes a distribution transformer 12 and a low voltage power conditioning device 14 that is incorporated with the transformer 12 to provide for output of a conditioned low voltage power that is suitable to drive a load or loads that are connected to the system 10. The transformer 12 includes a fluid enclosure or tank 16 having a front plate 18, sides 20, and a rear plate 22 that generally define a volume that houses a core and coil assembly and that provides a volume in which cooling fluid is contained/stored to immerse the core and coil assembly, as will be explained in greater detail below, with it being understood that the term “cooling fluid” as used herein is not meant to be limited to a liquid insulating medium, but may encompass any type of appropriate cooling fluid medium (gas, liquid, etc.).

Extending from the bottom of side edges of the enclosure 16 is a sill or risers 24 that includes sides and a front. Sill 24 is typically formed from a single piece of metal that is bent into the desired shape. Fluid enclosure 16 and riser 24 typically rest on a transformer pad 26 and are affixed thereto by bolts or the like. A cabinet door or other protective cover 28 may, in one embodiment, be pivotally attached to an upper edge of front plate 18 by means of hinges or the like and be configured to complement the space defined by riser 24 and front plate 18, so that when door 28 is closed, it rests on riser 24 and forms an interface with the fluid enclosure 16 and riser 24 and encloses electrical components extending through front plate 18. While the door or cover 28 is described above as being attached to an upper edge of front plate 18 and interacting with riser 24 to enclose the electrical components extending through front plate 18, it is recognized that the door or cover 28 may be provided in an alternative form. For example, door or cover 28 may be provided as a pair of doors that rotate outward on hinges located on side edges of front plate 18 or may be provided in other suitable forms or constructions that function to properly enclose the electrical components extending through front plate 18, with or without the use of a riser 24.

In one embodiment, one or more banks of corrugate 30 are provided on and as part of the enclosure 16—such that the enclosure 16 may be described as a “corrugated enclosure”—to provide for enhanced cooling of the cooling fluid therein. That is, a bank of corrugate 30 may be formed on one or more of sides 20 of enclosure 16, with each bank of corrugate 30 being formed of a plurality of cooling fins 32 that are welded to a wall of the enclosure 16 and spaced apart from one another a desired distance, with each of the cooling fins 32 having a hollow or semi-hollow construction, such that cooling fluid can be circulated therethrough from the enclosure 16.

As shown in FIG. 1, the power conditioning device 14 is integrated into system 10 and is secured to the transformer 12 on fluid enclosure 16. While FIG. 1 illustrates the power conditioning device 14 being secured onto the rear plate 22 of fluid enclosure 16, in other embodiments of the invention the power conditioning device 14 may instead be secured onto one of the side panels 20 or the front plate 18 of the fluid enclosure 16, or may instead be secured onto one of the top or bottom of the enclosure, or any other part thereof, or on cabinetry associated therewith, e.g., door or sill. In still another embodiment, the power conditioning device 14 can be a free-standing device placed within an enclosure and positioned on transformer pad 26, without mechanical attachment to the fluid enclosure 16, with the dimensions and the weight of the power conditioning device 14 being such that it would not allow any random movement thereof. Thus, while described here below as being secured onto the rear plate 22 of fluid enclosure 16, the scope of the invention is not to be limited to the specifically illustrated embodiment.

As shown in FIG. 1, according to one embodiment, the power conditioning device 14 includes an enclosure 34 that houses a power conditioning circuit 36 configured to receive a power output from transformer 12 and perform a conditioning or conversion of the received power in a desired fashion, as will be explained in greater detail below. The enclosure 34 may be constructed similar to cabinet door 28, such that it may be pivotally attached to an upper edge of rear plate 22 by means of hinges (not shown) and rotated upwardly to provide access to the power conditioning circuit 36. Alternatively, the enclosure 34 may include a pair of doors (not shown) that rotate on hinges and swing outwardly to provide access to the power conditioning circuit 36, or may have another suitable construction that provides for protection of and access to the power conditioning circuit 36. Standard fasteners of a known type may be used to secure enclosure 34 to the rear plate 22 of transformer fluid enclosure 16, with the fasteners coupling a back panel 38 of enclosure 34 to the rear plate 22 of transformer fluid enclosure 16. In an exemplary embodiment, the enclosure 34 is mounted to transformer 12 such that an air gap 40 is present between the enclosure 34 of power conditioning device 14 and the fluid enclosure 16 of transformer 12. The gap 40 may be in the form of a pair of channels formed on rear plate 22 or may be a continuous gap between the rear plate 22 and enclosure 34. This air gap 40 provides for efficient cooling of the power conditioning device 14 by providing for air flow (e.g., forced air flow) against the rear plate 22 and power conditioning circuit enclosure 34 and by providing additional surface area for convective heat transfer between the power conditioning device 14 and the ambient environment. In addition or alternative to the air gap 40, natural convection and/or liquid cooling systems may be employed to provide cooling to the power conditioning device 14. Additionally, in one embodiment, louvers 41 are formed on at least one wall/surface of the enclosure 34 (e.g., a side wall) to provide enhanced cooling to the power conditioning circuit 36.

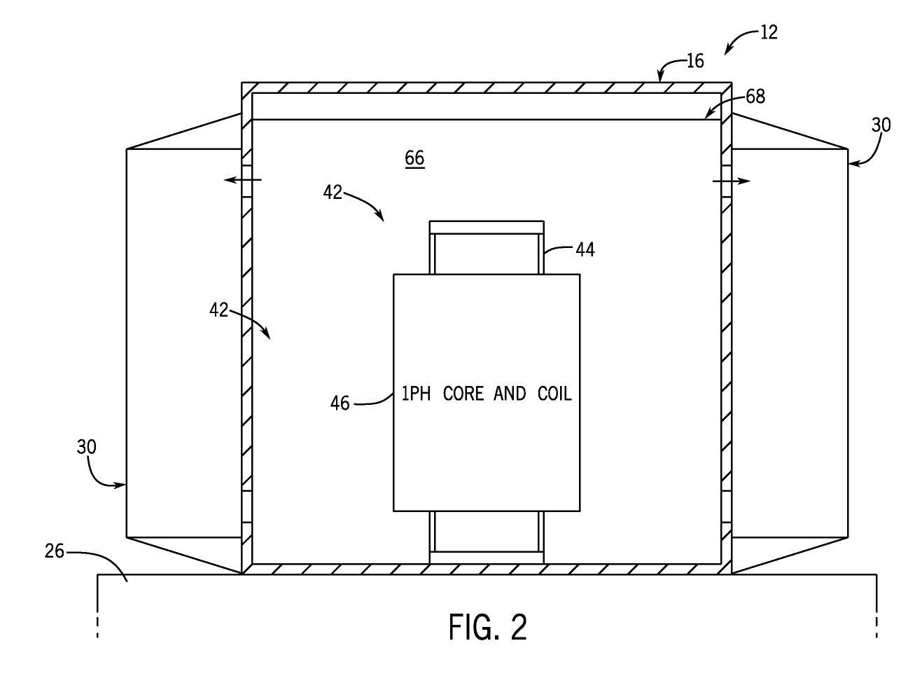

Referring now to FIG. 2, which is a cross-section view of the fluid enclosure 16 taken along line 2-2, an interior of the transformer 12 is shown to more fully illustrate and describe the transformer. As shown in FIG. 2, the fluid enclosure 16 houses a core and coil assembly 42 formed of a magnetic core 44 with windings 46 there-around. According to an embodiment of the invention, magnetic core and coil assembly 42 includes a single phase magnetic core 44. Magnetic core 44 can be formed of a plurality of stacks of magnetic, metallic laminations (not shown), such as grain-oriented silicon steel, for example. While transformer 12 is shown as including a single phase magnetic core 44, it is recognized that transformer 12 could also be configured as a three phase transformer or a voltage regulator.

The windings 46 disposed about magnetic core 44 are composed of a set of primary and secondary windings, with the sets of primary and secondary windings being connected in a known type of configuration. The windings 46 are formed from strips of electrically conductive material such as copper or aluminum and can be rectangular or round in shape, for example, although other materials and shapes may also be suitable. Individual turns of windings 46 are electrically insulated from each other by cellulose insulating paper (i.e., “Kraft paper”) to ensure that current travels throughout every winding turn and to protect the windings 46 from the high electrical and physical stresses present in the transformer.

As shown in FIG. 2, transformer 12 is configured as a liquid-filled transformer in that the core 44 and windings 46 are immersed in a bath of transformer fluid 66 (i.e., cooling fluid) that both cools and electrically insulates the windings 46. That is, cooling fluid 66 is a dielectric fluid that also exhibits desirable cooling properties. According to an exemplary embodiment, the cooling fluid 66 is in the form of an oil-based fluid having a high fire point (i.e., a less-flammable fluid). The cooling fluid 66 could be in form of a seed-, vegetable-, bio-, or natural ester-based oil or a silicone-based oil or synthetic hydrocarbon, that remains stable at transformer operating temperature conditions and provides superior heat transfer capabilities. It is also recognized, however, that other dielectric fluids could be utilized having suitable insulating and cooling properties, such as fluorinated hydrocarbons, for example, or any other dielectric fluid that exhibits desirable stability and heat transfer capabilities. The fluid enclosure 16 of transformer 12 is filled to a level 68 with the cooling fluid 66 to immerse the core 44 and windings 46.

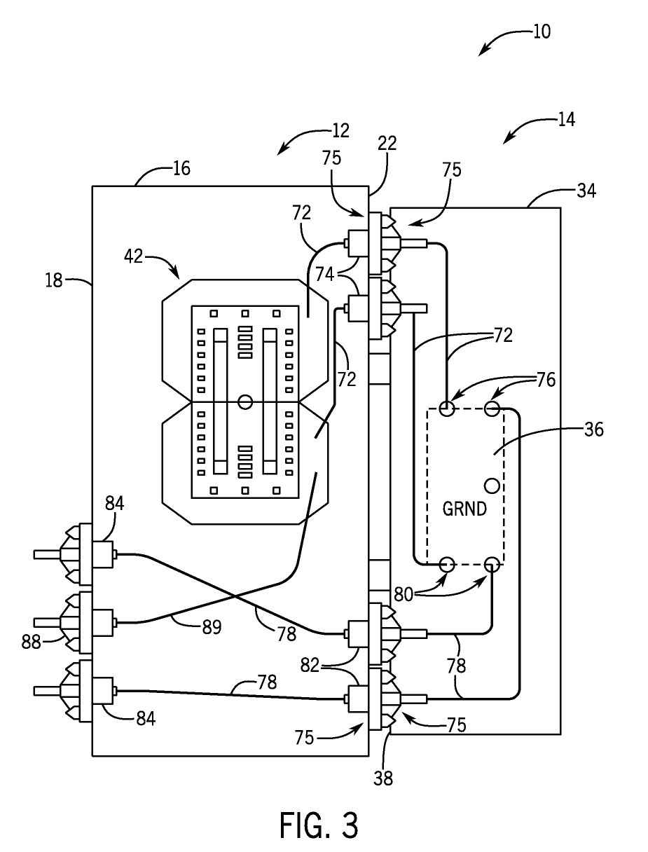

Referring now to FIG. 3, which is a cross-section view of the system taken along line 3-3, a low voltage wiring scheme for electrically connecting the transformer 12 to the power conditioning device 14 is illustrated, according to an exemplary embodiment. As seen in FIG. 3, a first set of electrical conductors 72 are provided off of a secondary (output) of the core and coil assembly 42 and are routed to a first pair of electrical connectors 74 included on the rear plate 22 of fluid enclosure 16 and back panel 38 of enclosure 34 of power conditioning device 14 (i.e., positioned in openings 75 formed in rear plate 22 and back panel 38) that provide electrical insulation and allow the electrical conductors 72 to pass through the plates/panels 22, 38. In an exemplary embodiment, the electrical connectors 74 are in the form of bushings (i.e., low voltage bushings) having a known construction. Thus, while not shown in FIG. 3, it is recognized that the bushings 74 may thus be formed out of an insulating material such as epoxy, for example, with cavities being formed in a mounting flange and a channel being formed through the center of the bushing to receive the conductor, and a threaded receptacle and threaded stud for coupling to the conductor and an external voltage lead/terminal. One or more gaskets may be used in combination with the bushing 74 to create a leak resistant seal between the bushing (i.e., annular mounting flange(s)) and the rear plates/panels, with the gasket(s) being formed of a non-conductive material such as rubber, for example.

The electrical conductors 72 connect to/through bushings 74 and are routed to an input 76 of the power conditioning circuit 36 of power conditioning device 14. The power conditioning circuit 36 may operate according to known techniques to dynamically (or according to other known, controlled techniques) control and condition power received from the transformer 12 for output to a load or loads connected to system 10. The power conditioning circuit 36 may thus dynamically control voltage, power factor and harmonics to more effectively increase energy efficiency, manage peak demand, support sensitive customer equipment, and increase overall system reliability. The power conditioning circuit 36 may therefore provide functionality including, but not limited to: load voltage regulation, such as by directly boosting and bucking voltage across a wide range during forward and reverse power flow; sag/swell mitigation to protect sensitive loads from voltage sags and swells caused by disturbances on the grid; reactive power compensation to regulate power factor by dynamically injecting or absorbing reactive power; and harmonic cancellation to correct source current and load voltage harmonic distortion and reduce overall total harmonic distortion (THD).

As can be seen in FIG. 3, upon performing a desired conditioning/converting of the power received from transformer 12, power is output from power conditioning circuit 36 to a second set of electrical conductors 78 coupled to outputs 80 of the power conditioning circuit 36. The electrical conductors 78 coupled to outputs 80 are then routed back into transformer 12 via a second pair of bushings 82 provided on the rear plate 22 of fluid enclosure 16 and back panel 38 of enclosure 34 of power conditioning device 14, with the bushings 82 providing electrical insulation and allowing the set of electrical conductors 78 to pass through the plates/panels 22, 38. The second pair of bushings 82 may have a known construction as described previously with respect to the first pair of bushings 74.

Upon being routed back into transformer 12, the second set of electrical conductors 78 is passed through the fluid enclosure 16 and through the electrically insulating transformer fluid 66 (i.e., immersed in the fluid 66). The electrical conductors 78 are routed through fluid enclosure 16 along a path that maintains an adequate separation between the conductors 78 and the core and coil assembly 42 (as well as any other components/devices within the enclosure, such as coolant circulation devices, for example), so as to ensure that no damage is done to the conductors 78. The electrical conductors 78 are then connected to a third pair of bushings 84 provided on the front plate 18 of fluid enclosure 16, with the bushings 84 providing electrical insulation and allowing the electrical conductors 78 to pass through the front plate 18. The bushings 84 on front plate 18 thus serve as electrical connections to the power system 10 and provide a conditioned, low voltage output that may be directly connected to a load or loads that receive power from the power system 10.

While the embodiment of FIG. 3 is shown and described as including electrical bushings 74, 82, 84, 88 for passing electrical conductors 72, 78 through the plates/panels 18, 22, 38 of enclosures 16, 34, it is recognized that other suitable connectors could alternatively be used. That is, connectors of different types and constructions from the bushing construction described above could instead by used to pass the electrical conductors 72, 78 through the plates/panels 18, 22, 38 of enclosures 16, 34, as long as such connectors provide the required electrical insulation and leak resistant sealing, and such connectors are considered to be within the scope of the invention. Additionally, it is recognized that alternate methods of connecting the power conditioning device 14 to any type of core and coil assembly 42 may be employed, and that embodiments of the invention are not meant to be limited only to the transformer schematic/construction illustrated in FIG. 3.

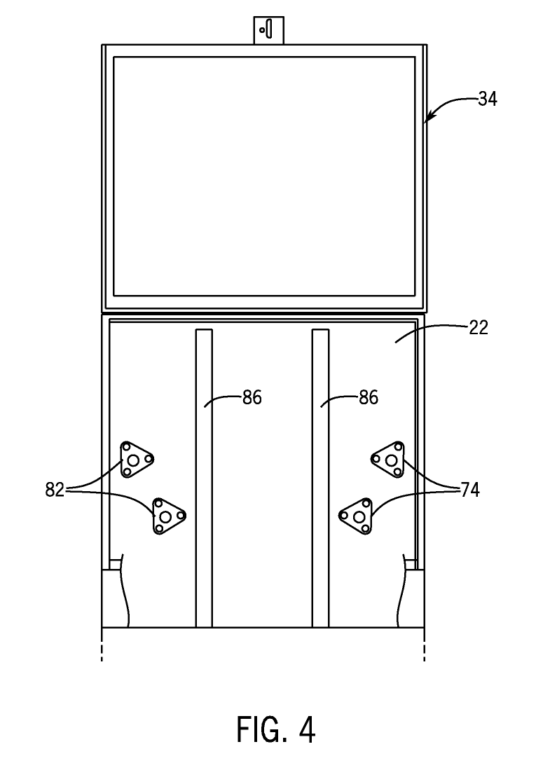

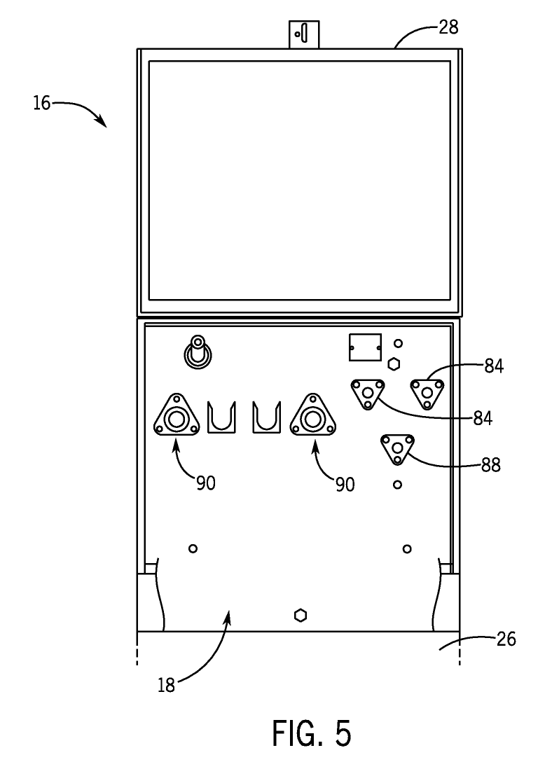

FIGS. 4 and 5 provide more detailed views of the rear plate 22 and front plate 18 of the fluid enclosure 16, respectively, according to an embodiment. Referring first to FIG. 4, the rear plate 22 of fluid enclosure 16 includes the first pair of bushings 74 and second pair of bushings 82 thereon that provide for routing of the first set of electrical conductors 72 out from transformer 12 (out from fluid enclosure 16) to the power conditioning device 14 and for routing of the second set of electrical conductors 78 from the power conditioning device 34 back to the transformer 12 (back into fluid enclosure 16). In an exemplary embodiment, rear plate 22 is constructed to include mounting channels 86 that are formed therein or welded thereto. The mounting channels 86 provide for the enclosure 34 of power conditioning device to be fastened and secured to fluid enclosure 16 and also additionally provide a path for air flow against the rear plate 22 and power conditioning circuit enclosure 34. As it is recognized that a substantial amount of heat may be generated by power conditioning circuit 36 during operation, the channels 86 help to ensure that sufficient cooling is provided to the power conditioning circuit. While a pair of mounting channels 86 is shown in FIG. 4, it is recognized that other suitable features could instead be employed for assisting with mounting of enclosure 34 and/or providing a path for air flow against the rear plate 22 and power conditioning circuit enclosure 34, and thus embodiments of the invention are not meant to be limited to the above described mounting channels. It is further recognized that the low voltage connections 74, 82 (e.g., bushings) can be mounted anywhere in any configuration on the said rear plate 22, and that these connections can be flush mounted to the plate, recessed, or fully exposed.

Referring now to FIG. 5, the front plate 18 of fluid enclosure 16 includes the third pair of bushings 84 thereon that provide for routing of the second set of electrical conductors 78 out through the front plate 18. An additional bushing 88 is also provided on front plate 18 and serves as a ground for the transformer 12 via an electrical conductor 89 connected from the core and coil assembly 42 to the bushing 88 (as also shown in FIG. 3), with bushing 88 allowing for connection of a ground clamp (not shown) thereto. Front plate 18 further includes various electrical fittings and components 90 connected to the transformer 12 and that extend through the front plate 18, with such fittings/components 90 including, for example, high voltage connections that may receive an input power from the grid for providing to the core and coil assembly 14.

Beneficially, embodiments of the invention thus provide a power system that includes a transformer and a power conditioning device integrated therewith. Power conditioning electronics are provided on a plate/panel of the transformer (e.g., rear panel), outside of the main transformer fluid enclosure in which insulating fluid is contained, with connections being routed through the fluid enclosure from the power conditioning electronics to the front plate of the enclosure. The power conditioning device is mounted on a transformer plate/panel that is similar to the front plate used for the high voltage and low voltage connections of the transformer, with the plate/panel replacing a blank panel presently used on the existing transformer fluid enclosures, and with connections routed through the fluid enclosure. The incorporation of the power conditioning electronics with the transformer provides a conditioned output that may be directly connected to a load or loads that receive power from the power system, with no additional hardware/connections being required on the low voltage bushings of the transformer front plate and eliminate. The incorporation of the power conditioning electronics with the transformer also allows for the elimination of addition low voltage cabling in the transformer connection compartment that is typically required when the power conditioning device is separate and/or remote from the transformer, while also providing enhanced power quality, such as by compensating for sags, swells, and harmonics to prevent tripping of sensitive customer equipment and extend customer and utility asset life.

Therefore, according to an embodiment of the invention, a power system comprises a transformer including a fluid enclosure configured to hold a transformer fluid therein and having a front plate, a rear plate, and side surfaces, the fluid enclosure configured to hold a transformer fluid therein, and a core and coil assembly positioned within the fluid enclosure so as to be immersed in the transformer fluid, the core and coil assembly including a transformer core and a plurality of windings wound about the transformer core. The power system also comprises a power conditioning device integrated with the transformer and connected thereto to receive an output power from the transformer, the power conditioning device including an electrical enclosure and a power conditioning circuit housed within the electrical enclosure and configured to perform power conversion and conditioning on the output power from the transformer. The power system further comprises a first set of electrical conductors coupled between the core and coil assembly and the power conditioning circuit to transfer the output power from the transformer to the power conditioning circuit and a second set of electrical conductors coupled between the power conditioning circuit and electrical connections on the front plate of the fluid enclosure, the second set of electrical conductors being routed through the fluid enclosure of the transformer.

According to another embodiment of the invention, an enclosure unit for an integrated transformer—power conditioning system includes a fluid tank configured to house a core and coil assembly of a transformer therein, with the fluid tank further including a front panel having electrical fittings thereon, a pair of side panels, and a rear panel, wherein one of the front panel, the side panels, and the rear panel comprises a plurality of openings formed therein. The enclosure unit also includes an electrical enclosure configured to house a power conditioning circuit therein, the electrical enclosure comprising a mounting panel having a plurality of openings formed therein, the mounting panel of the electrical enclosure mounted to the one of the front panel, the side panels, and the rear panel of the fluid tank having the plurality of openings formed therein. The enclosure unit further includes a plurality of electrical connectors positioned in the plurality of openings formed in the mounting panel of the electrical enclosure and in the plurality of openings formed in the one of the front panel, the side panels, and the rear panel of the fluid tank, the plurality of electrical connectors providing for a first set of electrical conductors to pass out from the fluid tank into the electrical enclosure and a second set of electrical conductors to pass out from the electrical enclosure back into the fluid tank.

According to yet another embodiment of the invention, an integrated transformer-voltage conversion system includes a transformer comprising a fluid tank comprising a front plate, a rear plate and side panels, a core and coil assembly positioned within the tank and including a transformer core and a plurality of windings wound about the transformer core, and a transformer fluid contained within the fluid tank and immersing the core and coil assembly. The system also includes a power conditioning device mounted on one of the front plate, the rear plate, or a respective side panel of the fluid tank, the power conditioning device electrically connected to the transformer to receive an output power therefrom and perform a power conditioning and conversion on the output power. The system further includes a first set of electrical conductors coupled between the transformer and the power conditioning device to transfer the output power from the transformer to the power conditioning device and a second set of electrical conductors coupled between the power conditioning device and electrical connections on the front plate of the fluid tank, wherein the second set of electrical conductors is routed through the fluid enclosure of the transformer so as to be immersed in the transformer fluid.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A power system comprising:
a transformer including:
a fluid enclosure comprising a front plate, a rear plate, and top, bottom, and side surfaces, the fluid enclosure configured to hold a transformer fluid therein; and
a core and coil assembly positioned within the fluid enclosure so as to be immersed in the transformer fluid, the core and coil assembly including a transformer core and a plurality of windings wound about the transformer core; and
a power conditioning device integrated with the transformer and connected thereto to receive an output power from the transformer, the power conditioning device including:
an electrical enclosure; and
a power conditioning circuit housed within the electrical enclosure and configured to perform power conversion and conditioning on the output power from the transformer;
a first set of electrical conductors coupled between the core and coil assembly and the power conditioning circuit to transfer the output power from the transformer to the power conditioning circuit; and
a second set of electrical conductors coupled between the power conditioning circuit and electrical connections on the front plate of the fluid enclosure, the second set of electrical conductors being routed through the fluid enclosure of the transformer.

2. The power system of claim 1 wherein the electrical connections on the front plate comprise low voltage electrical connectors configured to receive the second set of electrical conductors and provide a power output for the power system.

3. The power system of claim 1 further comprising:
a first pair of electrical connectors positioned on the fluid enclosure and the electrical enclosure of the power conditioning device, the first set of electrical conductors connected to the first pair of electrical connectors to pass from the transformer to the power conditioning device; and
a second pair of electrical connectors positioned on the fluid enclosure and the electrical enclosure of the power conditioning device, the second set of electrical conductors connected to the second pair of electrical connectors to pass from the power conditioning device back into the transformer;
wherein the first and second pairs of electrical connectors comprise electrically insulating and leak resistant connectors.

4. The power system of claim 1 wherein the electrical enclosure of the power conditioning device is spaced apart from the fluid enclosure of the transformer so as to provide an air gap therebetween, the air gap providing cooling to the power conditioning circuit.

5. The power system of claim 1 wherein the fluid enclosure comprises a plurality of mounting channels formed therein configured to receive fasteners for mounting the electrical enclosure of the power conditioning device, the mounting channels providing an air flow path between the fluid enclosure and the electrical enclosure of the power conditioning device.

6. The power system of claim 1 wherein the electrical enclosure of the power conditioning device is mounted on one of the rear plate, the front plate, or the top, bottom, or side surfaces of the fluid enclosure of the transformer.

7. The power system of claim 1 wherein the power conditioning circuit is configured to control and condition the output power received from the transformer, so as to control at least one of voltage, power factor, and harmonics.

8. The power system of claim 1 wherein the second set of electrical conductors is routed through the fluid enclosure of the transformer so as to be immersed in the transformer fluid.

9. The power system of claim 1 wherein the second set of electrical conductors is routed through the fluid enclosure so as to be spaced apart from the core and coil assembly.

10. The power system of claim 1 further comprising:
a grounding bushing positioned on the front plate of the fluid enclosure; and
an additional electrical conductor connected between the core and coil assembly and the grounding bushing.

11. The power system of claim 1 further comprising a single mounting pad on which the transformer and power conditioning device are both mounted.

12. The power system of claim 1 wherein the electrical enclosure of the power conditioning device comprises louvers formed in at least one wall of the enclosure, the louvers providing cooling to the power conditioning circuit.

13. An enclosure unit for an integrated transformer—power conditioning system, the enclosure unit comprising:
a fluid tank configured to house a core and coil assembly of a transformer therein, the fluid tank comprising:
a front panel having electrical fittings thereon;
a pair of side panels; and
a rear panel;
wherein one of the front panel, the side panels, and the rear panel comprises a plurality of openings formed therein;
an electrical enclosure configured to house a power conditioning circuit therein, the electrical enclosure comprising a mounting panel having a plurality of openings formed therein, the mounting panel of the electrical enclosure mounted to the one of the front panel, the side panels, and the rear panel of the fluid tank having the plurality of openings formed therein;
a plurality of electrical connectors positioned in the plurality of openings formed in the mounting panel of the electrical enclosure and in the plurality of openings formed in the one of the front panel, the side panels, and the rear panel of the fluid tank, the plurality of electrical connectors providing for a first set of electrical conductors to pass out from the fluid tank into the electrical enclosure and a second set of electrical conductors to pass out from the electrical enclosure back into the fluid tank.

14. The enclosure unit of claim 13 wherein the mounting panel of the electrical enclosure is affixed to the one of the front panel, the side panels, and the rear panel of the fluid tank having the plurality of openings formed therein such that an air gap is formed between the back panel and the respective fluid tank panel.

15. The enclosure unit of claim 13 wherein the one of the front panel, the side panels, and the rear panel of the fluid tank having the plurality of openings formed therein comprises a plurality of mounting channels or other suitable methods either welded or formed therein configured to receive fasteners for mounting the electrical enclosure, the mounting channels providing an air flow path between the respective panel of the fluid tank and the electrical enclosure.

16. The enclosure unit of claim 13 wherein the plurality of electrical connectors and the plurality of openings comprises:
a first pair of electrical bushings positioned in a first pair of openings formed in the respective panel of the fluid tank and in the mounting panel of the electrical enclosure, the first pair of electrical bushings providing for the first set of electrical conductors to pass from the fluid tank into the electrical enclosure; and
a second pair of electrical bushings positioned in a second pair of openings formed in the respective panel of the fluid tank and in the mounting panel of the electrical enclosure, the second pair of electrical bushings providing for the second set of electrical conductors to pass from the electrical enclosure into the fluid tank.

17. The enclosure unit of claim 13 wherein the fluid tank and the electrical enclosure are sized to fit on a single transformer mounting pad.

18. An integrated transformer-voltage conversion system comprising:
a transformer comprising:
a fluid tank comprising a front plate, a rear plate and side panels;
a core and coil assembly positioned within the tank and including a transformer core and a plurality of windings wound about the transformer core; and
a transformer fluid contained within the fluid tank and immersing the core and coil assembly;
a power conditioning device mounted on one of the front plate, the rear plate, or a respective side panel of the fluid tank, the power conditioning device electrically connected to the transformer to receive an output power therefrom and perform a power conditioning and conversion on the output power;
a first set of electrical conductors coupled between the transformer and the power conditioning device to transfer the output power from the transformer to the power conditioning device; and
a second set of electrical conductors coupled between the power conditioning device and electrical connections on the front plate of the fluid tank;
wherein the second set of electrical conductors is routed through the fluid enclosure of the transformer so as to be immersed in the transformer fluid.

19. The integrated transformer-voltage conversion system of claim 18 wherein the power conditioning device includes:
an electrical enclosure mounted to the one of the front plate, the rear plate, or the respective side panel of the fluid tank; and
a power conditioning circuit housed within the electrical enclosure and configured to perform the power conditioning and conversion on the output power from the transformer;
wherein the electrical enclosure is mounted to the one of the front plate, the rear plate, or the respective side panel of the fluid tank such that at least one of an air gap and air channels are present between the electrical enclosure and the respective plate or panel, so as to provide an air flow for cooling the power conditioning circuit.

20. The integrated transformer-voltage conversion system of claim 18 further comprising:
a first pair of electrical connectors positioned on the one of the front plate, the rear plate, or the respective side panel of the fluid tank and on the electrical enclosure, the first set of electrical conductors connected to the first pair of electrical connectors to pass from the transformer to the power conditioning device; and
a second pair of electrical connectors positioned on the one of the front plate, the rear plate, or the respective side panel of the fluid tank and on the electrical enclosure, the second set of electrical conductors connected to the second pair of electrical connectors to pass from the power conditioning device back into the transformer;
wherein the first and second pairs of electrical connectors comprise electrically insulating and leak resistant connectors.
